(19) United States
(12) Patent Application Publication
(10) Pub. No.: US 2012/0194667 A1
(43) Pub. Date: Aug. 2, 2012

(54) TURBINE ENGINE THERMAL IMAGING SYSTEM

(75) Inventors: Ayan Banerjee, Nadia (IN); Sandip Maity, Bangalore (IN); Rajagopalan Chandrasekharan, Bangalore (IN); Sheri George, Bangalore (IN); Anusha Rammohan, Bangalore (IN)

(73) Assignee: General Electric Company, Schenectady, NY (US)

(21) Appl. No.: 13/018,128

(22) Filed: Jan. 31, 2011

(51) Int. Cl. H04N 7/18

(52) U.S. Cl. 348/135; 348/E07.085

(57) ABSTRACT

In one embodiment, a system includes an imaging system configured to capture a first image of a rotating component within an interior of a turbine using a first integration time, to capture a second image of the rotating component within the interior of the turbine using a second integration time, different than the first integration time, and to subtract the first image from the second image to obtain a differential image.

### BACKGROUND OF THE INVENTION

The subject matter disclosed herein relates to a turbine engine thermal imaging system.

Certain gas turbine engines include a turbine having viewing ports configured to facilitate monitoring of various components within the turbine. For example, a pyrometry system may receive radiation signals through the viewing ports to measure the temperature of certain components within a hot gas path of the turbine. The pyrometry system may include a sensor configured to measure radiation within an infrared spectrum, and a controller configured to convert the radiation measurement into a temperature map of the components. Unfortunately, variations in emissivity of the components may interfere with the temperature computation. For example, emissivity may vary over time due to changes in temperature, buildup of residue on the components, oxidation of turbine components and/or dirt accumulation on the viewing port window. Consequently, in certain circumstances, employing infrared measurements to compute temperature may produce inaccurate temperature maps of the components.

In addition, due to the high speed rotation of certain turbine components (e.g., turbine blades), a camera having a short integration time may be employed to capture images of the components. For example, cameras having an integration time of about 1 microsecond may be employed to capture images of turbine blades rotating at about 50 Hz. The short integration time enables the camera to capture high spatial resolution images. Unfortunately, such cameras may be very expensive.

### BRIEF DESCRIPTION OF THE INVENTION

In one embodiment, a system includes an imaging system configured to optically communicate with an interior of a turbine. The imaging system includes at least one camera configured to receive multiple visual spectrum images of a rotating component within the interior of the turbine, and to output signals indicative of a two-dimensional intensity profile of each visual spectrum image. The imaging system also includes a controller communicatively coupled to the at least one camera and configured to determine a two-dimensional temperature map of the rotating component based on the signals. The imaging system is configured to capture a first visual spectrum image of the rotating component using a first integration time, to capture a second visual spectrum image of the rotating component using a second integration time, different than the first integration time, and to subtract the first visual spectrum image from the second visual spectrum image to obtain a differential image.

In another embodiment, a system includes an imaging system configured to capture a first image of a rotating component within an interior of a turbine using a first integration time, to capture a second image of the rotating component within the interior of the turbine using a second integration time, different than the first integration time, and to subtract the first image from the second image to obtain a differential image.

In a further embodiment, a system includes an imaging system configured to optically communicate with an interior of a turbine. The imaging system includes a camera configured to receive a visual spectrum image of a component within the interior of the turbine, and to output signals indicative of a two-dimensional intensity profile of the visual spectrum image. The imaging system also includes a controller communicatively coupled to the camera and configured to determine a two-dimensional temperature map of the component based on the signals.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an embodiment of a turbine system including an imaging system configured to determine a two-dimensional temperature map of a turbine component based on a visual spectrum image and/or to compute a high spatial resolution differential image of the component;

FIG. 2 is a cross-sectional view of an exemplary turbine section, illustrating various turbine components that may be monitored by an embodiment of the imaging system;

FIG. 3 is a schematic diagram of an embodiment of the imaging system having a controller configured to receive signals indicative of a visual spectrum image of a turbine component and to determine a two-dimensional temperature map based on the signals; and

FIG. 4 is a schematic diagram of an embodiment of the imaging system having a controller configured to compute a differential image of a turbine component based on first and second images, each having a different integration time.

### DETAILED DESCRIPTION OF THE INVENTION

One or more specific embodiments will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments disclosed herein, the articles “a,” “an,” “the,” and “said” are intended to mean that there are one or more of the elements. The terms “comprising,” “including,” and “having” are intended to be inclusive and mean that there may be additional elements other than the listed elements.

Embodiments disclosed herein may provide enhanced temperature measurements and/or higher spatial resolution images of turbine components. In one embodiment, an imaging system is configured to optically communicate with an interior of a turbine. The imaging system includes at least one camera configured to receive multiple visual spectrum images of a rotating component within the interior of the turbine, and to output signals indicative of a two-dimensional intensity profile of each visual spectrum image. The imaging system also includes a controller communicatively coupled to the at least one camera and configured to determine a two-dimensional temperature map of the rotating component based on the signals. Because the two-dimensional temperature map is based on a visual spectrum image, the computed temperatures within the temperature map may be more accurate than temperatures computed from infrared spectrum images. Specifically, temperature computations based on visual wavelength emissions are less dependent on variations in emissivity than computations based on infrared radiation. Therefore, the controller will provide accurate temperature maps despite buildup of residue on the rotating component, oxidation of the rotating component and/or dirt accumulation on a viewing port window. In addition, in one embodiment, the imaging system is configured to capture a first visual spectrum image of the rotating component using a first integration time, to capture a second visual spectrum image of the rotating component using a second integration time, different than the first integration time, and to subtract the first visual spectrum image from the second visual spectrum image to obtain a differential image. The differential image may have a spatial resolution substantially similar to an image with an integration time equal to the difference between the first integration time and the second integration time. Because cameras capable of operating at longer integration times are significantly less expensive than cameras capable of operating at shorter integration times, the imaging system may provide an economically feasible system for generating images with high spatial resolution.

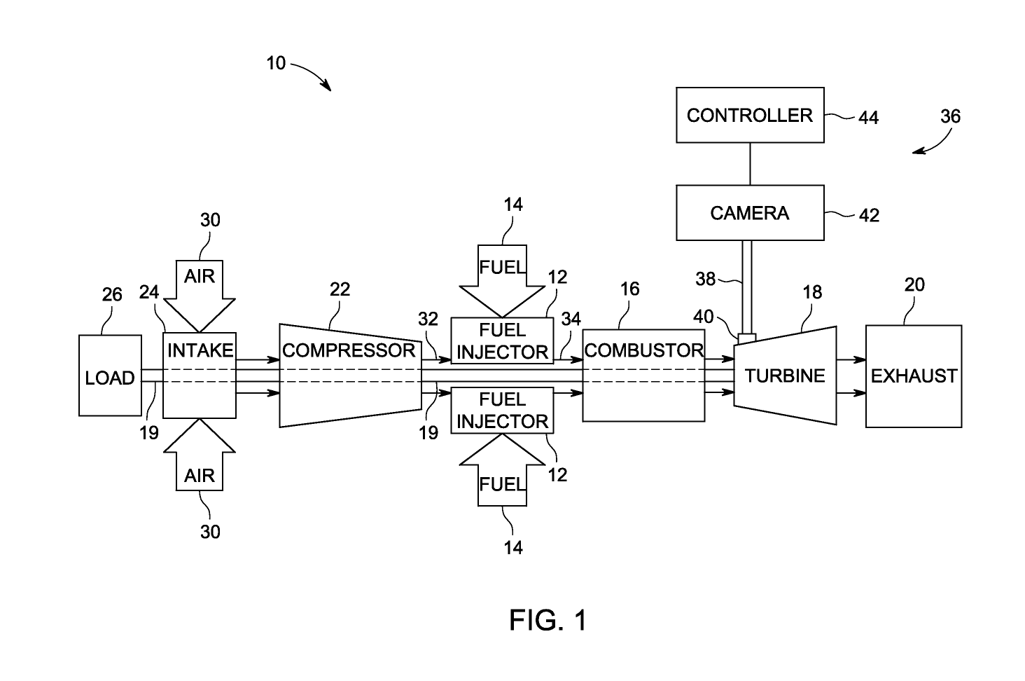

Turning now to the drawings, FIG. 1 is a block diagram of an embodiment of a turbine system including an imaging system configured to determine a two-dimensional temperature map of a turbine component based on a visual spectrum image and/or to compute a high spatial resolution differential image of the component. The turbine system 10 includes a fuel injector 12, a fuel supply 14, and a combustor 16. As illustrated, the fuel supply 14 routes a liquid fuel and/or gas fuel, such as natural gas, to the gas turbine system 10 through the fuel injector 12 into the combustor 16. As discussed below, the fuel injector 12 is configured to inject and mix the fuel with compressed air. The combustor 16 ignites and combusts the fuel-air mixture, and then passes hot pressurized exhaust gas into a turbine 18. As will be appreciated, the turbine 18 includes one or more stators having fixed vanes or blades, and one or more rotors having blades which rotate relative to the stators. The exhaust gas passes through the turbine rotor blades, thereby driving the turbine rotor to rotate. Coupling between the turbine rotor and a shaft 19 will cause the rotation of the shaft 19, which is also coupled to several components throughout the gas turbine system 10, as illustrated. Eventually, the exhaust of the combustion process may exit the gas turbine system 10 via an exhaust outlet 20.

A compressor 22 includes blades rigidly mounted to a rotor which is driven to rotate by the shaft 19. As air passes through the rotating blades, air pressure increases, thereby providing the combustor 16 with sufficient air for proper combustion. The compressor 22 may intake air to the gas turbine system 10 via an air intake 24. Further, the shaft 19 may be coupled to a load 26, which may be powered via rotation of the shaft 19. As will be appreciated, the load 26 may be any suitable device that may use the power of the rotational output of the gas turbine system 10, such as a power generation plant or an external mechanical load. For example, the load 26 may include an electrical generator, a propeller of an airplane, and so forth. The air intake 24 draws air 30 into the gas turbine system 10 via a suitable mechanism, such as a cold air intake. The air 30 then flows through blades of the compressor 22, which provides compressed air 32 to the combustor 16. In particular, the fuel injector 12 may inject the compressed air 32 and fuel 14, as a fuel-air mixture 34, into the combustor 16. Alternatively, the compressed air 32 and fuel 14 may be injected directly into the combustor for mixing and combustion.

As illustrated, the turbine system 10 includes an imaging system 36 optically coupled to the turbine 18. In the illustrated embodiment, the imaging system 36 includes an optical connection 38 (e.g., fiber optic cable, optical waveguide, etc.) extending between a viewing port 40 into the turbine 18 and a camera 42. As discussed in detail below, the camera 42 is configured to obtain a two-dimensional visual spectrum image of a component within the turbine 18 through the viewing port 40. The camera 42 is communicatively coupled to a controller 44 which is configured to determine a two-dimensional temperature map of the component based on the visual spectrum image. Because the two-dimensional temperature map is based on a visual spectrum image, the computed temperatures within the temperature map may be more accurate than temperatures computed from infrared spectrum images. In addition, in one embodiment, the imaging system is configured to capture a first visual spectrum image of the component using a first integration time, to capture a second visual spectrum image of the component using a second integration time, different than the first integration time, and to subtract the first visual spectrum image from the second visual spectrum image to obtain a differential image. The differential image may have a spatial resolution substantially similar to an image with an integration time equal to the difference between the first integration time and the second integration time. Because cameras capable of operating at longer integration times are significantly less expensive than cameras capable of operating at shorter integration times, the imaging system may provide an economically feasible system for generating images with high spatial resolution.

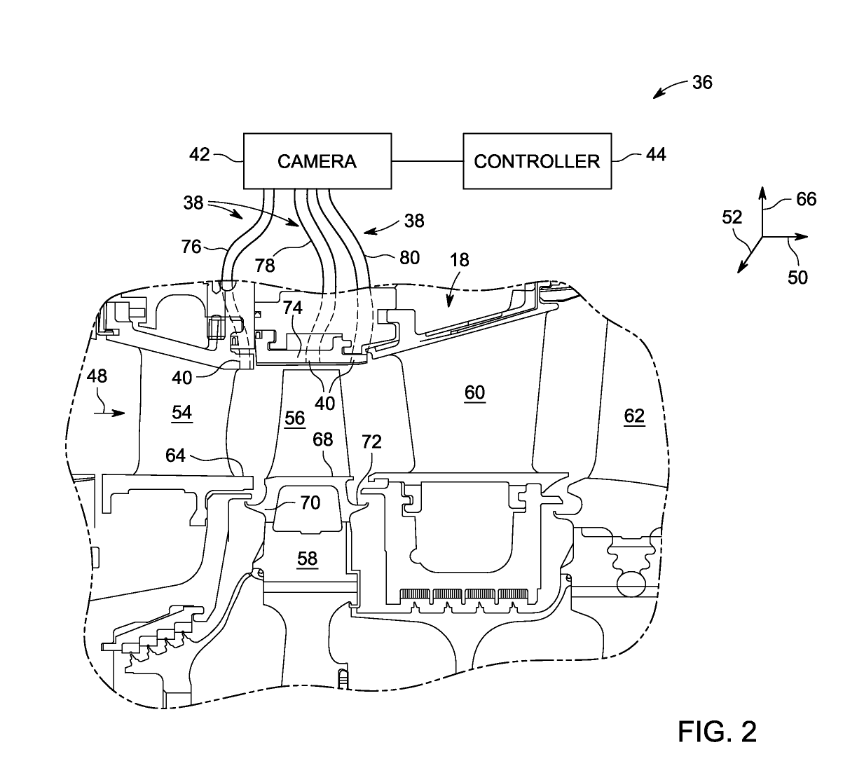

FIG. 2 is a cross-sectional view of a turbine section, illustrating various turbine components that may be monitored by the imaging system 36. As illustrated, exhaust gas 48 from the combustor 16 flows into the turbine 18 in an axial direction 50 and/or a circumferential direction 52. The illustrated turbine 18 includes at least two stages, with the first two stages shown in FIG. 2. Other turbine configurations may include more or fewer turbine stages. For example, a turbine may include 1, 2, 3, 4, 5, 6, or more turbine stages. The first turbine stage includes vanes 54 and blades 56 substantially equally spaced in the circumferential direction 52 about the turbine 18. The first stage vanes 54 are rigidly mounted to the turbine 18 and configured to direct combustion gases toward the blades 56. The first stage blades 56 are mounted to a rotor 58 that is driven to rotate by the exhaust gas 48 flowing through the blades 56. The rotor 58, in turn, is coupled to the shaft 19, which drives the compressor 22 and the load 26. The exhaust gas 48 then flows through second stage vanes 60 and second stage blades 62. The second stage blades 62 are also coupled to the rotor 58. As the exhaust gas 48 flows through each stage, energy from the gas is converted into rotational energy of the rotor 58. After passing through each turbine stage, the exhaust gas 48 exits the turbine 18 in the axial direction 50.

In the illustrated embodiment, each first stage vane 54 extends outward from an endwall 64 in a radial direction 66. The endwall 64 is configured to block hot exhaust gas 48 from entering the rotor 58. A similar endwall may be present adjacent to the second stage vanes 60, and subsequent downstream vanes, if present. Similarly, each first stage blade 56 extends outward from a platform 68 in the radial direction 66. As will be appreciated, the platform 68 is part of a shank 70 which couples the blade 56 to the rotor 58. The shank 70 also includes a seal, or angel wing, 72 configured to block hot exhaust gas 48 from entering the rotor 58. Similar platforms and angel wings may be present adjacent to the second stage blades 62, and subsequent downstream blades, if present. Furthermore, a shroud 74 is positioned radially outward from the first stage blades 56. The shroud 74 is configured to minimize the quantity of exhaust gas 48 that bypasses the blades 56. Gas bypass is undesirable because energy from the bypassing gas is not captured by the blades 56 and translated into rotational energy. While embodiments of the imaging system 36 are described below with reference to monitoring components within the turbine 18 of a gas turbine engine 10, it should be appreciated that the imaging system 36 may be employed to monitor components within other rotating and/or reciprocating machinery, such as a turbine in which steam or another working fluid passes through turbine blades.

As will be appreciated, various components within the turbine 18 (e.g., vanes 54 and 60, blades 56 and 62, endwalls 64, platforms 68, angel wings 72, shrouds 74, etc.) will be exposed to the hot exhaust gas 48 from the combustor 16. Consequently, it may be desirable to measure a temperature of certain components during operation of the turbine 18 to ensure that the temperature remains within a desired range and/or to monitor thermal stress within the components. For example, the imaging system 36 may be configured to capture a two-dimensional visual spectrum image of the first stage turbine blades 56. The two-dimensional visual spectrum image may then be used to compute a two-dimensional temperature map of the surface of the blades 56. Because the two-dimensional temperature map is based on a visual spectrum image, the computed temperatures within the temperature map may be more accurate than temperatures computed from infrared spectrum images.

As illustrated, the imaging system 36 includes three viewing ports 40 directed toward different regions of the blade 56. Three optical connections 38 optically couple the viewing ports 40 to the camera 42. A first optical connection 76 is configured to convey an image of an upstream portion of the blade 56 to the camera 42, a second optical connection 78 is configured to convey an image of a circumferential side of the blade 56 to the camera 42, and a third optical connection 80 is configured to convey an image of a downstream portion of the blade 56 to the camera 42. The viewing ports 40 may be angled in the axial direction 50, circumferential direction 52 and/or radial direction 66 to direct the viewing ports 40 toward desired regions of the blade 56. In alternative embodiments, more or fewer viewing ports 40 and optical connections 38 may be employed to obtain images of the first stage blade 56. For example, certain embodiments may employ 1, 2, 3, 4, 5, 6, 7, 8, or more viewing ports 40 and a corresponding number of optical connections 38 to convey images of the blade 56 to the camera 42. As will be appreciated, the more viewing ports 40 and optical connections 38 employed, the more regions of the blade 56 that may be monitored. As previously discussed, the optical connections 38 may include a fiber optic cable or an optical waveguide, for example. It should also be appreciated that certain embodiments may omit the optical connections 38, and the camera 42 may be directly optically coupled to the viewing ports 40.

While the viewing ports 40 are directed toward the first stage blades 56 in the illustrated embodiment, it should be appreciated that the viewing ports 40 may be directed toward other turbine components in alternative embodiments. For example, one or more viewing ports 40 may be directed toward the first stage vanes 54, the second stage vanes 60, the second stage blades 62, the endwalls 64, the platforms 68, the angel wings 72, the shrouds 74, or other components within the turbine 18. Further embodiments may include viewing ports 40 directed toward multiple components within the turbine 18. Similar to the first stage blades 56, the imaging system 36 may capture a two-dimensional visual spectrum image of each component within a field of view of a viewing port 40, and determine a two-dimensional temperature map based on the visual spectrum image. In this manner, an operator may readily identify excessive temperature variations across the component and/or defects (e.g., cracks, blocked cooling holes, etc.) within the turbine component.

As previously discussed, the optical connections 38 (e.g., fiber optic cable, optical waveguide, etc.) convey an image from the turbine 18 to the camera 42. The camera 42 may be configured to capture multiple images over a period of time. As will be appreciated, certain turbine components, such as the first stage blades 56 described above, may rotate at high speed along the circumferential direction 52 of the turbine 18. Consequently, to capture an image of such components, the camera 42 may be configured to operate at an integration time sufficient to provide the controller 44 with a substantially still image of each component. For example, in certain embodiments, the camera 42 may be configured to output a signal indicative of the visual image of the turbine component with an integration time shorter than about 10, 5, 3, 2, 1, or 0.5 microseconds, or less. Alternatively, the controller may be configured to capture a first visual spectrum image of the rotating component using a first integration time, to capture a second visual spectrum image of the rotating component using a second integration time, different than the first integration time, and to subtract the first visual spectrum image from the second visual spectrum image to obtain a differential image. The differential image may have a spatial resolution substantially similar to an image with an integration time equal to the difference between the first integration time and the second integration time. Because cameras capable of operating at longer integration times are significantly less expensive than cameras capable of operating at shorter integration times, the imaging system may provide an economically feasible system for generating images with high spatial resolution.

In certain embodiments, the optical connections 38 may be coupled to a multiplexer within the camera 42 to facilitate monitoring images from each observation point. As will be appreciated, images from each optical connection 38 may be multiplexed in space or time. For example, if the multiplexer is configured to multiplex the images in space, each image may be projected onto a different portion of an image sensing device (e.g., charge-coupled device (CCD), complementary metal oxide semiconductor (CMOS), etc.) within the camera 42. In this configuration, an image from the first optical connection 76 may be directed toward an upper portion of the image sensing device, an image from the second optical connection 78 may be directed toward a central portion of the image sensing device, and an image from the third optical connection 80 may be directed toward a lower portion of the image sensing device. As a result, the image sensing device may scan each image at one-third resolution. In other words, scan resolution is inversely proportional to the number of spatially multiplexed signals. As will be appreciated, lower resolution scans provide the controller 44 with less information about the turbine component than higher resolution scans. Therefore, the number of spatially multiplexed signals may be limited by the minimum resolution sufficient for the controller 44 to establish a desired two-dimensional image of the turbine component.

Alternatively, images provided by the optical connections 38 may be multiplexed in time. For example, the camera 42 may alternately scan an image from each optical connection 38 using the entire resolution of the image sensing device. Using this technique, the full resolution of the image sensing device may be utilized, but the scanning frequency may be reduced proportionally to the number of observation points scanned. For example, if two observation points are scanned and the image sensing device frequency is 100 Hz, the camera 42 is only able to scan images from each observation point at 50 Hz. Therefore, the number of temporally multiplexed signals may be limited by the desired scanning frequency.

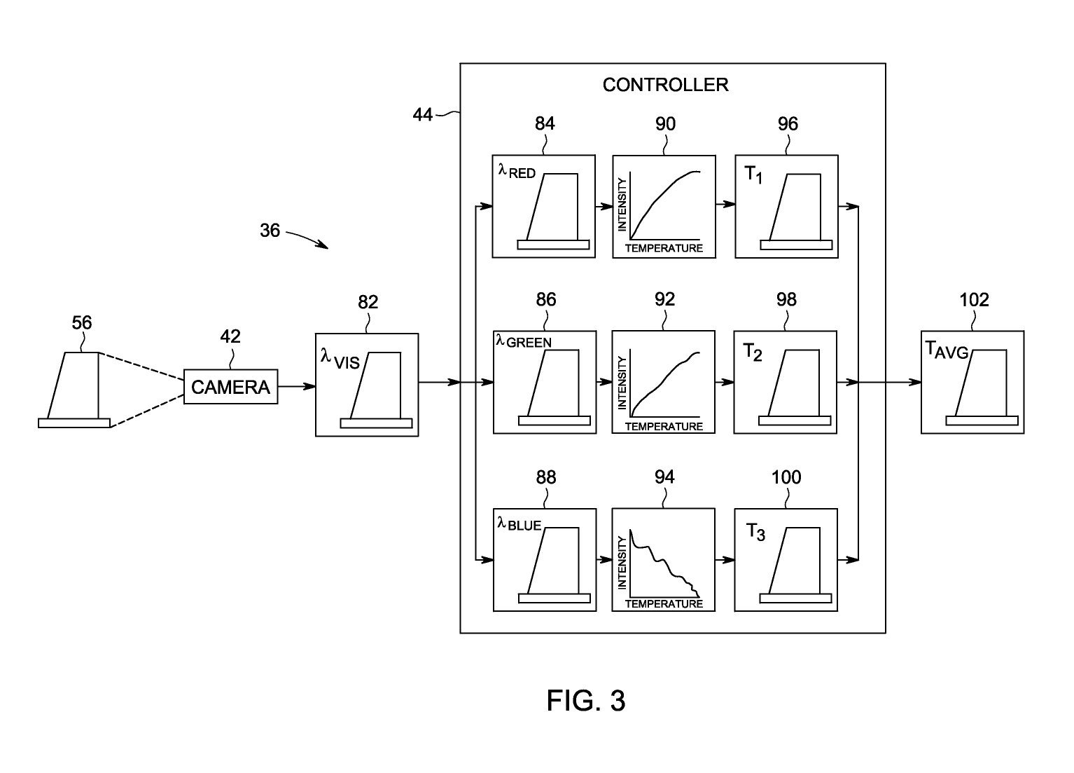

FIG. 3 is a schematic diagram of an embodiment of the imaging system having a controller configured to receive signals indicative of a visual spectrum image of a turbine component and to determine a two-dimensional temperature map based on the signals. As illustrated, the camera 42 is directed toward a first stage turbine blade 56. However, it should be appreciated that the camera 42 may be directed toward other turbine components (e.g., vanes 54 and 60, blades 62, endwalls 64, platforms 68, angel wings 72, shrouds 74, etc.) in alternative embodiments. In addition, multiple cameras 42 may be utilized in alternative embodiments. For example, in certain embodiments 1, 2, 3, 4, 5, 6, 7, 8, or more cameras 42 may be directed toward the blade 56. As previously discussed, further embodiments may include multiple optical connections 38 extending between the turbine 18 and a multiplexer within each camera 42.

In the illustrated embodiment, the camera 42 is configured to receive a visual spectrum image of the turbine blade 56, and to output signals to the controller 44 indicative of a two-dimensional intensity profile 82 of the visual spectrum image. For example, the camera 42 may include an image sensing device sensitive to radiation within the visible spectrum. Such an image sensing device may be configured to convert visible radiation emitted and reflected by the turbine components into an electrical signal for processing by the controller 44. As will be appreciated, the image sensing device may be a charge-coupled device (CCD), a complementary metal oxide semiconductor (CMOS), a focal plane array (FPA), or any other suitable device for converting visual spectrum electromagnetic radiation into electrical signals. In certain embodiments, the image sensing device may be configured to detect visual spectrum radiation within a wavelength range of about 350 nm to about 750 nm, about 375 nm to about 725 nm, or about 400 nm to about 700 nm, for example. Accordingly, the spectral content of the two-dimensional intensity profile 82 will include radiation within the visual range of the electromagnetic spectrum.

Moreover, it should be appreciated that a variety of camera configurations may be employed to capture the visual spectrum image of the turbine component. For example, in certain embodiments, a consumer-grade digital single-lens reflex (SLR) camera may be utilized to receive the visual spectrum image, and to output signals to the controller 44 indicative of the two-dimensional intensity profile 82 of the visual spectrum image. SLR cameras includes a reflex mirror that selectively transitions between a first position that directs incoming light toward an eyepiece, and a second position that directs the incoming light toward the image sensing device. In this configuration, an operator may utilize the eyepiece to direct the SLR camera toward a desired target (e.g., turbine blade 56). Once aligned, the SLR camera may be activated, thereby transitioning the reflex mirror to the second position and enabling the imaging sensing device to capture the visual spectrum image. As will be appreciated, alternative embodiments may employ other camera configurations which do not include the reflex mirror or eyepiece.

As illustrated, the signals indicative of the two-dimensional intensity profile 82 are transmitted to the controller 44. As previously discussed, the controller 44 is configured to determine a two-dimensional temperature map of the component (e.g., turbine blade 56) based on the signals. In the illustrated embodiment, the controller is configured to computationally split the two-dimensional intensity profile 82 in multiple narrow wavelength band intensity profiles. For example, the controller 44 may be configured to split the intensity profile 82 into a red intensity profile 84, a green intensity profile 86 and a blue intensity profile 88. In such a configuration, the red intensity profile 84 may include wavelengths within a range of about 600 nm to about 750 nm, the green intensity profile 86 may include wavelengths within a range of about 475 nm to about 600 nm, and the blue intensity profile may include wavelengths within a range of about 400 nm to about 475 nm. The controller 44 may be configured to split the two-dimensional intensity profile into the narrow wavelength band intensity profiles by applying a series of computational filters that progressively extract the profiles having the desired wavelength ranges. Alternatively, the signals indicative of the two dimensional intensity profile 82 may include red, green and blue components corresponding to respective detectors within the image sensing device. In such a configuration, the controller 44 may separate the signals into the constituent components to establish the narrow wavelength band intensity profiles. While red, green and blue intensity profiles are described above, it should be appreciated that alternative embodiments may utilize other narrow wavelength band intensity profiles having different wavelength ranges.

In the illustrated embodiment, the controller 44 is configured to compute two-dimensional temperature maps based on the narrow wavelength band intensity profiles. As illustrated, the controller 44 includes a first temperature conversion curve 90 configured to map the intensity of each pixel within the red intensity profile 84 to a corresponding temperature. Similarly, the controller 44 includes a second temperature conversion curve 92 for the green intensity profile 86, and a third temperature conversion curve 94 for the blue intensity profile 88. While each temperature conversion curve is shown as a continuous curve, it should be appreciated that the controller 44 may employ an empirical formula, a lookup table, an interpolation system (e.g., linear interpolation, least squares, cubic spline, etc.), or other technique to map the intensity of each pixel to a corresponding temperature. Consequently, the controller 44 will generate a first two-dimensional temperature distribution 96 based on the red intensity profile 84, a second two-dimensional temperature distribution 98 based on the green intensity profile 86, and a third two-dimensional temperature distribution 100 based on the blue intensity profile 88. The controller 44 may then average each temperature distribution to establish an output temperature map 102. Because the temperature map 102 is based on an average of three colors, the temperature map 102 may include more accurate temperatures than temperature maps based on individual colors.

While three temperature distributions are averaged in the illustrated embodiment, it should be appreciated that more or fewer temperature distributions may be utilized in alternative embodiments. For example, in certain embodiments, the temperature map 102 may be computed from a single narrow wavelength band intensity profile (e.g., the red intensity profile 84). Alternatively, two of the three illustrated temperature distributions (e.g., the first and second temperature distributions 96 and 98) may be averaged to generate the output temperature map 102. In further embodiments, the controller 44 may be configured to split the two-dimensional intensity profile 82 into 4, 5, 6, 7, 8, 9, 10, or more narrow wavelength band intensity profiles, and to generate temperature distributions based on each intensity profile. In such embodiments, all, or a selected portion, of the temperature distributions may be averaged to provide the output temperature map 102.

In other embodiments, the controller 44 may be configured to employ multi-wavelength techniques to generate the output temperature map 102. As will be appreciated, emissivity may vary over time due to changes in temperature, buildup of residue on the components, oxidation of turbine components and/or dirt accumulation on the viewing port window. Consequently, the controller 44 may be configured to utilize multi-wavelength techniques in combination with the red, green and blue intensity profiles to compute an apparent-effective emissivity of the turbine component. By including emissivity in the temperature map computations, a more accurate temperature map may be generated.

Because the illustrated embodiment utilizes a camera 42 sensitive to visible radiation, the imaging system 36 may be less expensive to manufacture than imaging systems employing infrared cameras. For example, as discussed above, the camera 42 may be a consumer-grade digital SLR camera. Such a camera may be significantly less expensive than a camera sensitive to infrared radiation. In addition, the digital SLR camera may have a significantly higher resolution than an infrared camera, thereby enabling the imaging system 36 to detect smaller defects and/or temperature variations within the turbine component. Furthermore, temperature computations based on visual wavelength emissions are less dependent on variations in emissivity than computations based on infrared radiation. Therefore, the computed temperatures within the temperature map 102 may be more accurate than temperatures based on images from infrared cameras.

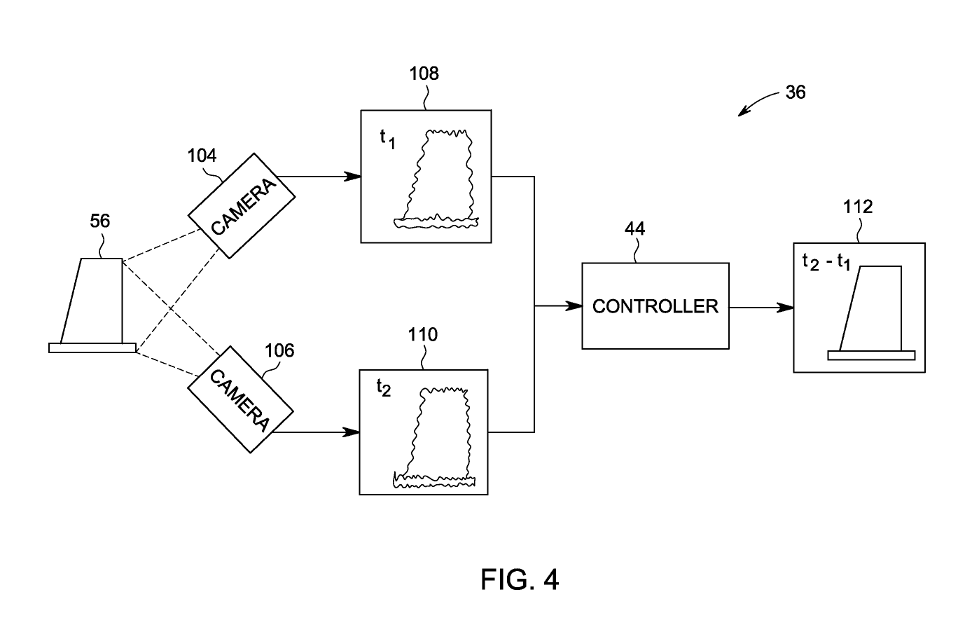

FIG. 4 is a schematic diagram of an embodiment of the imaging system 36 having a controller 44 configured to compute a differential image of a turbine component based on first and second images, each having a different integration time. As illustrated, a first camera 104 and a second camera 106 are directed toward the first stage turbine blade 56. The first camera 104 is configured to capture a first image 108 using a first integration time t₁, and the second cameral 106 is configured to capture a second image 110 using a second integration time t₂. As will be appreciated, integration time may be defined as the duration of turbine component exposure to the image sensing device. Due to the high rotation speed of certain turbine components (e.g., turbine blades 56), a short integration time may be desirable to produce an image with high spatial resolution (e.g., a sharp image that facilitates identification of minute features). By way of example, a 1 microsecond integration time may be utilized to achieve a 500 micron spatial resolution within an image of a turbine blade rotating at 50 Hz. Unfortunately, due to the cost associated with cameras having 1 microsecond integration times, imaging systems employing such cameras may be economically infeasible for turbine component monitoring. Consequently, the illustrated imaging system 36 may utilize cameras 104 and 106 having longer integration times, and a controller 44 configured to generate a high spatial resolution image from multiple long integration time images.

In the illustrated embodiment, the controller 44 is configured to receive the first image 108 having the first integration time t₁, and the second image 110 having the second integration time t₂, longer than the first integration time t₁. The controller 44 is also configured to subtract the first image 108 from the second image 110, thereby generating a differential image 112 having a spatial resolution substantially similar to an image with an integration time of t₂−t₁. By way of example, the first image 108 may have an integration time of 49 microseconds, and the second image 110 may have an integration time of 50 microseconds. Such integration times may produce images with spatial resolutions insufficient to identify defects within the turbine blades 56. However, by subtracting the first image 108 from the second image 110, the controller 44 will generate a differential image 112 having a spatial resolution substantially similar to an image with a 1 microsecond integration time (i.e., 50 microseconds minus 49 microseconds). Consequently, the image 112 may have a 500 micron spatial resolution, thereby enabling an operator or an automatic system to identify defects (e.g., cracks, blocked cooling holes, etc.) within the turbine component. Because cameras capable of operating at about 50 microsecond integration times are significantly less expensive than cameras capable of operating at 1 microsecond integration times, the illustrated imaging system 36 may provide an economically feasible system for generating images with high spatial resolution.

While the controller 44 is configured to directly subtract the first and second images in the illustrated embodiment, it should be appreciated that the controller may be configured to apply a weighting factor, either linear or non-linear, to one or both of the images prior to subtraction. In addition, while two cameras 104 and 106 are employed in the illustrated embodiment, it should be appreciated that alternative embodiments may utilize a single camera to generate the first and second images. For example, the camera may be configured to capture the first image when the turbine blade 56 is positioned at a particular circumferential position. The camera may then capture the second image of the same turbine blade 56 as the turbine blade passes the particular circumferential position during a subsequent rotation. Similar to the two camera configuration, the first integration time of the first image is different than the second integration time of the second image, thereby enabling the controller 44 to generate a differential imaging having high spatial resolution. For example, the spatial resolution of the differential image may be substantially similar to a spatial resolution of an image having an integration time equal to the difference between the first integration time and the second integration time.

Furthermore, it should be appreciated that the controller 44 may determine a two-dimensional temperature map 102 of the turbine component based on the differential image 112. For example, the controller 44 may be configured to split the differential image 112 into multiple narrow wavelength band intensity profiles, and compute respective two-dimensional temperature distributions based on temperature conversion curves. The controller 44 may then average the respective temperature distributions to produce the two-dimensional temperature map of the turbine component. The combination of an accurate temperature map and high spatial resolution will enable an operator or automated system to identify defects within the component and/or to identify temperature distributions that may be indicative of excessive wear.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system comprising:
an imaging system configured to optically communicate with an interior of a turbine, comprising:
at least one camera configured to receive a plurality of visual spectrum images of a rotating component within the interior of the turbine, and to output signals indicative of a two-dimensional intensity profile of each visual spectrum image; and
a controller communicatively coupled to the at least one camera and configured to determine a two-dimensional temperature map of the rotating component based on the signals;
wherein the imaging system is configured to capture a first visual spectrum image of the rotating component using a first integration time, to capture a second visual spectrum image of the rotating component using a second integration time, different than the first integration time, and to subtract the first visual spectrum image from the second visual spectrum image to obtain a differential image.

2. The system of claim 1, wherein the controller is configured to filter the signals to obtain a two-dimensional narrow wavelength band intensity profile of each visual spectrum image, and to determine the two-dimensional temperature map of the rotating component based on the two-dimensional narrow wavelength band intensity profile.

3. The system of claim 2, wherein the two-dimensional narrow wavelength band intensity profile comprises a wavelength range of about 600 nm to about 750 nm.

4. The system of claim 1, wherein the controller is configured to filter the signals to obtain a plurality of two-dimensional narrow wavelength band intensity profiles of each visual spectrum image, and to determine the two-dimensional temperature map of the rotating component based on the plurality of two-dimensional narrow wavelength band intensity profiles.

5. The system of claim 4, wherein the controller is configured to determine a respective two-dimensional temperature distribution for each two-dimensional narrow wavelength band intensity profile, and to determine the two-dimensional temperature map by averaging each respective two-dimensional temperature distribution.

6. The system of claim 1, wherein a spatial resolution of the differential image is substantially similar to a spatial resolution of an image having an integration time equal to a difference between the first integration time and the second integration time.

7. The system of claim 1, wherein the imaging system comprises a first camera configured to capture the first visual spectrum image, and a second camera configured to capture the second visual spectrum image, wherein the first camera and the second camera are configured to capture the first and second visual spectrum images simultaneously.

8. The system of claim 1, wherein the imaging system comprises a single camera configured to capture the first and second visual spectrum images when the rotating component is aligned with the single camera.

9. The system of claim 1, wherein the at least one camera is configured to optically couple to a viewing port into the turbine via a fiber optic cable or an imaging optical system.

10. The system of claim 1, wherein the at least one camera comprises a digital single-lens reflect camera.

11. A system comprising:
an imaging system configured to capture a first image of a rotating component within an interior of a turbine using a first integration time, to capture a second image of the rotating component within the interior of the turbine using a second integration time, different than the first integration time, and to subtract the first image from the second image to obtain a differential image.

12. The system of claim 11, wherein a spatial resolution of the differential image is substantially similar to a spatial resolution of an image having an integration time equal to a difference between the first integration time and the second integration time.

13. The system of claim 11, wherein the imaging system comprises a first camera configured to capture the first image, and a second camera configured to capture the second image, wherein the first camera and the second camera are configured to capture the first and second images simultaneously.

14. The system of claim 11, wherein the imaging system comprises a single camera configured to capture the first and second images when the rotating component is aligned with the single camera.

15. The system of claim 11, wherein the imaging system is configured to capture visual wavelengths of the first and second images.

16. A system comprising:
an imaging system configured to optically communicate with an interior of a turbine, comprising:
a camera configured to receive a visual spectrum image of a component within the interior of the turbine, and to output signals indicative of a two-dimensional intensity profile of the visual spectrum image; and
a controller communicatively coupled to the camera and configured to determine a two-dimensional temperature map of the component based on the signals.

17. The system of claim 16, wherein the controller is configured to filter the signals to obtain a two-dimensional narrow wavelength band intensity profile of the visual spectrum image, and to determine the two-dimensional temperature map of the component based on the two-dimensional narrow wavelength band intensity profile.

18. The system of claim 17, wherein the two-dimensional narrow wavelength band intensity profile comprises a wavelength range of about 600 nm to about 750 nm.

19. The system of claim 16, wherein the controller is configured to filter the signals to obtain a plurality of two-dimensional narrow wavelength band intensity profiles of the visual spectrum image, and to determine the two-dimensional temperature map of the component based on the plurality of two-dimensional narrow wavelength band intensity profiles.

20. The system of claim 19, wherein the controller is configured to determine a respective two-dimensional temperature distribution for each two-dimensional narrow wavelength band intensity profile, and to determine the two-dimensional temperature map by averaging each respective two-dimensional temperature distribution.
